(19) United States
(12) Patent Application Publication
(10) Pub. No.: US 2013/0115481 A1
(43) Pub. Date: May 9, 2013

(54) BATTERY PACK

(71) Applicant: Youn-Gu KIM, Yongin-si (KR)

(72) Inventor: Youn-Gu KIM, Yongin-si (KR)

(21) Appl. No.: 13/527,504

(22) Filed: Jun. 19, 2012

Related U.S. Application Data
(60) Provisional application No. 61/557,696, filed on Nov. 9, 2011.

(51) Int. Cl. H01M 2/00

(52) U.S. Cl. 429/7

(57) ABSTRACT

A battery pack including: a bare cell including an electrode assembly, a can accommodating the electrode assembly, and a terminal electrically coupled to the electrode assembly; a protection circuit module electrically connected to the bare cell; and a first lead plate connected between the protection circuit module and the terminal, and the protection circuit module is offset from the terminal in a first direction toward a side of the bare cell at a first end of the bare cell.

### CROSS-REFERENCE TO RELATED APPLICATION

This application claims priority to and the benefit of U.S. Provisional Application No. 61/557,696, filed on Nov. 9, 2011 in the United States Patent and Trademark Office, the entire content of which is incorporated herein by reference.

### BACKGROUND

1. Field

Aspects of embodiments of the present invention relate to a battery pack.

2. Description of the Related Art

Unlike primary batteries that are not rechargeable, secondary batteries are rechargeable batteries. Secondary batteries are broadly used in compact high-technology electronic devices such as cellular phones, personal digital assistants (PDAs), and laptop computers, and are also used in energy storage systems.

In consideration of safety, a secondary battery may include a module for detecting a malfunction such as overheating or overcurrent and performing a protection operation such as current blocking.

### SUMMARY

According to an aspect of embodiments of the present invention, a battery pack includes a bare cell and a protection circuit module having a connection structure which reduces a required mounting space and may thereby increase a capacity of the battery pack.

According to another aspect of embodiments of the present invention, a battery pack includes a protection circuit device having a connection structure having a variable length such that the protection circuit module may be used with bare cells of various sizes and shapes.

According to an embodiment of the present invention, a battery pack includes: a bare cell including an electrode assembly, a can accommodating the electrode assembly, and a terminal electrically coupled to the electrode assembly; a protection circuit module electrically connected to the bare cell; and a first lead plate connected between the protection circuit module and the terminal, and the protection circuit module is offset from the terminal in a first direction toward a side of the bare cell at a first end of the bare cell.

The protection circuit module may include a circuit board and a protection device mounted to a side of the circuit board facing the bare cell. The battery pack may further include an insulation case including a base between and separating the bare cell and the protection device.

The insulation case may further include a barrier wall extending from the base, the barrier wall between and separating the protection device and another device mounted to the side of the circuit board.

The insulation case may further include first and second side walls extending from the base and defining a recess therebetween receiving the protection device.

A length of the circuit board along a lengthwise direction of the first end of the bare cell may be less than half of a length of the first end of the bare cell along the lengthwise direction.

The protection circuit module may include a circuit board and a first connection pad on the circuit board, and the first lead plate may extend from a side of the protection circuit module toward a second direction opposite the first direction and contact a portion of the first connection pad. The first lead plate may partially overlap the first connection pad.

The bare cell may further include a cap plate closing an opening of the can, the terminal protruding through the cap plate to an outside of the can, and the battery pack may further include a second lead plate connecting the protection circuit module to the cap plate. The second lead plate may be bent toward a bending direction and have a length in the bending direction corresponding to a height of the terminal from the cap plate.

The first lead plate may extend substantially straight from a side of the protection circuit module toward a second direction opposite the first direction.

The battery pack may further include an insulation case between the bare cell and the protection circuit module.

The insulation case may be offset from the terminal in the first direction toward the side of the bare cell.

The insulation case may have a first opening exposing the terminal for connection to the first lead plate. The insulation case may include a barrier wall at a location corresponding to a side of the terminal opposite the protection circuit module.

The insulation case may have a length greater than a total length of the protection circuit module and the first lead plate. The bare cell may further include an electrolyte inlet at a side of the first end opposite the protection circuit module, and the insulation case may have a second opening at a location corresponding to the electrolyte inlet.

A length of the first opening along a lengthwise direction of the first end of the bare cell may be greater than a length of the terminal along the lengthwise direction. The protection circuit module may be spaced apart from the bare cell.

The battery pack may further include an insulation sheet between the bare cell and the insulation case at a location corresponding to the protection circuit module.

### BRIEF DESCRIPTION OF THE DRAWINGS

The accompanying drawings, together with the specification, illustrate some exemplary embodiments of the present invention, and, together with the description, serve to explain aspects and principles of the present invention.

FIG. 1 is an exploded perspective view of a battery pack according to an embodiment of the present invention.

FIG. 2 is a partial exploded side view of a bare cell, an insulation case, and a protection circuit module of the battery pack of FIG. 1.

FIG. 3 is a partial side view of a bare cell, an insulation case, and a protection circuit module of a battery pack according to another embodiment of the present invention.

FIG. 4 is a lower perspective view of the protection circuit module of the battery pack of FIG. 1.

FIGS. 5A through 5C are bottom views showing a method of adjusting or varying a length of a lead plate of the protection circuit module of FIG. 4.

FIG. 6 is an exploded perspective view of a battery pack according to another embodiment of the present invention.

FIG. 7 is a partial exploded perspective view of a bare cell, an insulation case, and a protection circuit module of the battery pack of FIG. 6.

FIG. 8 is a partial exploded perspective view of a bare cell, an insulation case, and a protection circuit module of a battery pack according to another embodiment of the present invention.

Description of Reference Numerals Indicating
Some Elements in the Drawings

| | |
|---|---|
| 100, 600: battery pack | 110, 610: bare cell |
| 111, 611: can | 112, 612: cap plate |
| 113, 613: electrode terminal | 120, 620: protection circuit module |
| 121, 621: circuit board | 122, 622: protection device |
| 123, 623: safety device | 125, 625: external terminal |
| 126, 626: first lead plate | 127, 627: second lead plate |
| 130, 630: insulation case | 140, 640: upper cover |
| 150, 650: lower cover | 160, 660: label |

### DETAILED DESCRIPTION

The present invention will be described more fully hereinafter with reference to the accompanying drawings, in which some exemplary embodiments of the invention are shown and described. However, as those skilled in the art would realize, the described embodiments may be modified in various different ways, all without departing from the spirit or scope of the present invention. Accordingly, the drawings and description are to be regarded as illustrative in nature and not restrictive. The terminology used herein is for the purpose of describing particular embodiments and is not intended to limit the invention. As used herein, the singular forms “a,” “an,” and “the” are intended to include the plural forms as well, unless the context clearly indicates otherwise. It will be further understood that the terms “comprises” and/or “comprising,” when used herein, specify the presence of stated features, integers, steps, operations, elements, and/or components, but do not preclude the presence or addition of one or more other features, integers, steps, operations, elements, components, and/or groups thereof. Also, it will be understood that, although the terms “first,” “second,” etc. may be used herein to describe various elements, these elements should not be limited by these terms. These terms are only used to distinguish one element from another. For purposes of description, like reference numerals are used, where possible, to designate like elements that are common to the drawings.

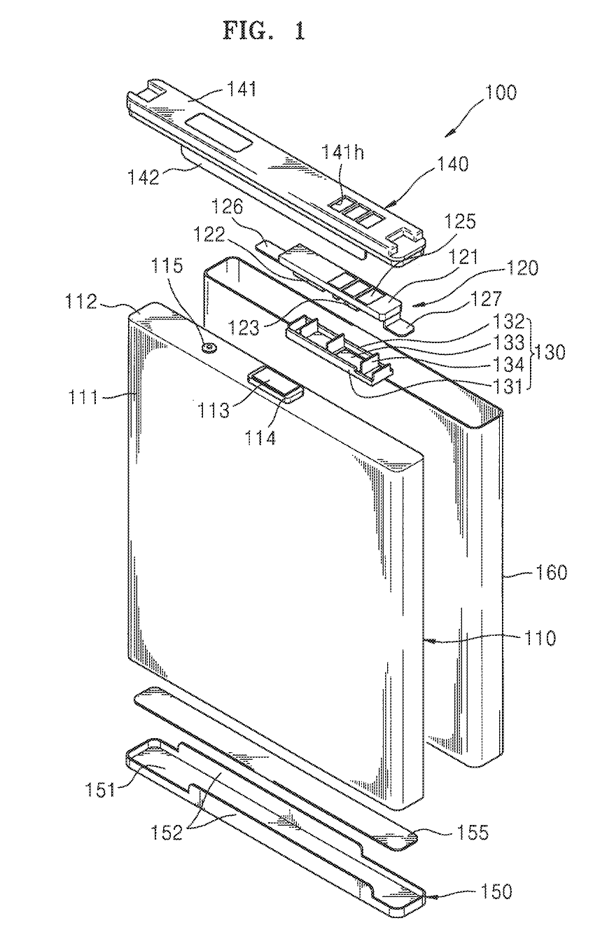

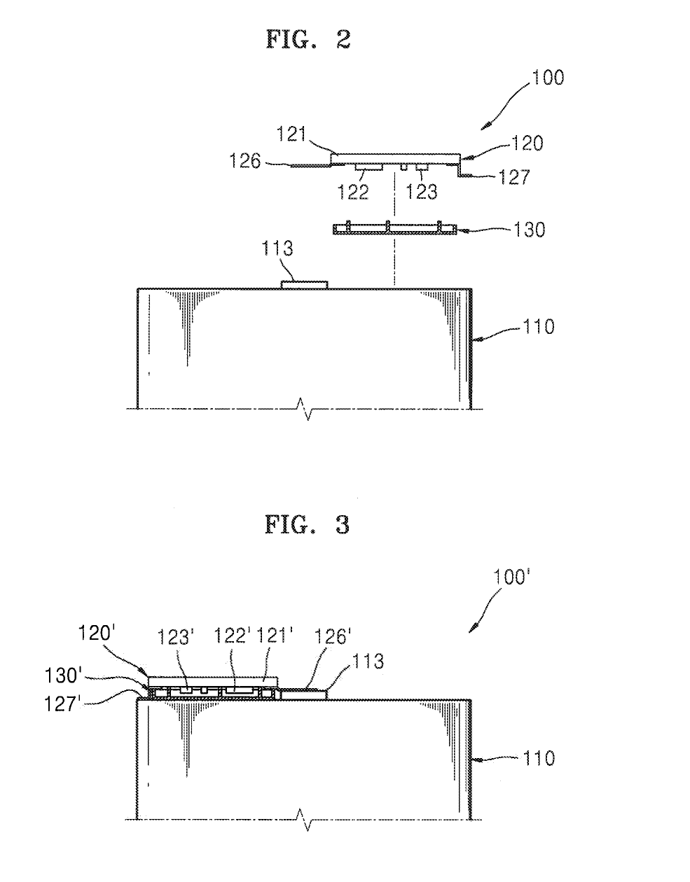

FIG. 1 is an exploded perspective view of a battery pack 100 according to an embodiment of the present invention. FIG. 2 is a partial exploded side view of a bare cell 110, an insulation case 130, and a protection circuit module 120 of the battery pack 100 illustrated in FIG. 1.

Referring to FIG. 1, the battery pack 100, in one embodiment, may include the bare cell 110, the protection circuit module 120, the insulation case 130, an upper cover 140, a lower cover 150, and a label 160. The battery pack 100 includes first and second lead plates 126 and 127 to electrically connect the protection circuit module 120 to the bare cell 110. In one embodiment, a total length of the protection circuit module 120 (i.e. a length of the protection circuit module 120 including the first and second lead plates 126 and 127) may be adjusted or varied, such as according to a size of the bare cell 110. The first and second lead plates 126 and 127 are elements for electrically connecting the protection circuit module 120 to the bare cell 110, and are not included in the protection circuit module 120. However, for convenience of explanation, it is described herein that the first and second lead plates 126 and 127 are included in the protection circuit module 120.

The bare cell 110 supplies electrical energy. The bare cell 110 may include an electrode assembly (not shown), a can 111 for accommodating the electrode assembly and an electrolyte (not shown), and a cap plate 112 for closing an open end of the can 111. The electrode assembly includes a negative electrode plate (not shown) coated with a negative electrode active material, a positive electrode plate (not shown) coated with a positive electrode active material, and a separator (not shown) disposed between the negative and positive electrode plates. The electrode assembly, in one embodiment, may be formed by winding the positive electrode plate, the negative electrode plate, and the separator in the form of jelly roll.

The electrode assembly may be accommodated in the can 111 while being soaked in the electrolyte. The open end of the can 111 may be closed by the cap plate 112. The cap plate 112 and the can 111 may be sealed together by using, for example, a laser welding method. In one embodiment, an electrolyte inlet for injecting the electrolyte is formed in the cap plate 112, and is sealed with a stopper 115.

The cap plate 112 may be formed of a metallic material, and an electrode terminal 113 protrudes from the cap plate 112. In one embodiment, for example, the electrode terminal 113 may be disposed at the center of the cap plate 112. A gasket 114 for insulating the electrode terminal 113 from the cap plate 112 may be disposed between the electrode terminal 113 and the cap plate 112.

In one embodiment, the can 111 and the cap plate 112 may function as a terminal (e.g., a positive electrode terminal) of the bare cell 110. In one embodiment, the electrode terminal 113 protruding from the cap plate 112 may function as a negative electrode terminal of the bare cell 110.

Referring to FIGS. 1 and 2, the protection circuit module 120 is disposed on and electrically connected to the bare cell 110. An external terminal 125 to be electrically connected to an external electronic device (not shown) may be formed on an upper surface of a circuit board 121 of the protection circuit module 120. The protection circuit module 120, in one embodiment, includes the circuit board 121, and a protection device 122 and a safety device 123 mounted on the circuit board 121 to protect the bare cell 110 from overcharge, over-discharge, and/or high temperature.

The circuit board 121, in one embodiment, may have a length less than half of a length of an upper surface of the bare cell 110, and more particularly, a length less than or equal to a length from one end of the electrode terminal 113 to one end of the bare cell 110. The protection device 122 and the safety device 123 may be mounted on a lower surface of the circuit board 121 in order to increase the efficiency of space.

The protection device 122 may include a switch unit electrically connected to a wiring pattern formed on the circuit board 121 so as to form a charge or discharge current path, and a control unit. The protection device 122 may be formed as one chip mounted on the circuit board 121.

The safety device 123, in one embodiment, is a secondary device and controls or blocks a charge or discharge current when a malfunction such as overheating or overcurrent occurs. The safety device 123 may include a positive temperature coefficient (PTC), a fuse, a current blocking device, or a bi-metal. The electrode terminal 113 may be electrically connected to the safety device 123 via the wiring pattern formed on the circuit board 121. Accordingly, when the bare cell 110 is overheated, overcharged, or over-discharged, the safety device 123 may ensure the safety of the bare cell 110 by blocking a flow of current.

In one embodiment, the circuit board 121 has a length less than half of the length of the upper surface of the bare cell 110, and the protection circuit module 120 is disposed at a side of the electrode terminal 113 on the upper surface of the bare cell 110. The protection circuit module 120 is electrically connected to the bare cell 110 via the first and second lead plates 126 and 127.

In one embodiment, the first lead plate 126 may be connected at a side of the protection circuit module 120 and may contact and be electrically connected to the electrode terminal 113 functioning as a negative electrode terminal, and the second lead plate 127 may be formed at another side of the protection circuit module 120 and may contact and be electrically connected to the cap plate 112 functioning as a positive electrode terminal.

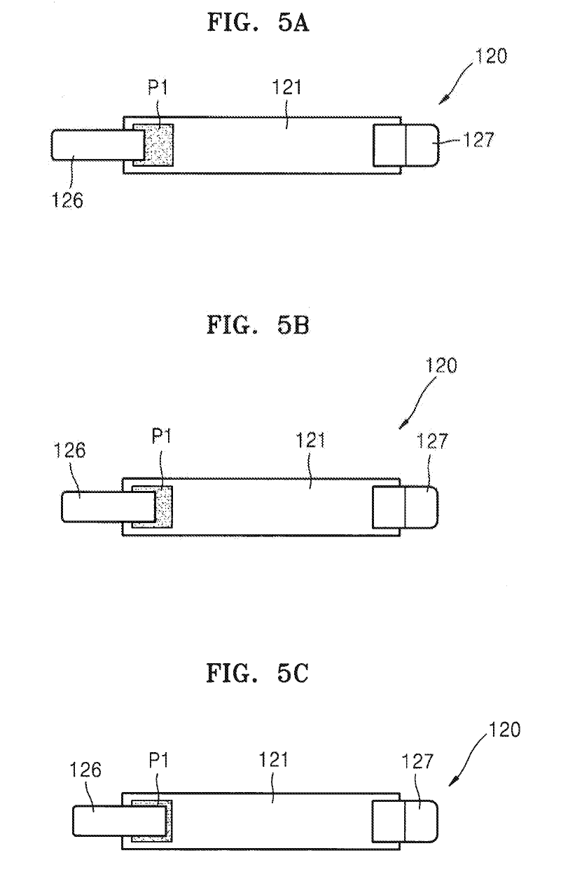

The first and second lead plates 126 and 127 may be respectively bonded onto the electrode terminal 113 and the cap plate 112. When the first and second lead plates 126 and 127 are bonded onto the circuit board 121, the total length of the protection circuit module 120 may be changed by adjusting or varying positions of the first and second lead plates 126 and 127. Further description of the adjustable or variable total length of the protection circuit module 120 is provided below with reference to FIGS. 5A through 5C.

The insulation case 130, in one embodiment, is disposed between the bare cell 110 and the protection circuit module 120. The insulation case 130 may insulate the protection device 122 and the safety device 123 mounted on the lower surface of the circuit board 121 from the cap plate 112, and may be formed, for example, by extruding an insulation material.

The insulation case 130, in one embodiment, may include first and second side walls 131 and 132 extending along a lengthwise direction of the insulation case 130, barrier walls 134 formed substantially perpendicularly to the first and second side walls 131 and 132, and a lower surface 133. The first and second side walls 131 and 132, in one embodiment, may be spaced apart from each other by a distance substantially equal to a width of the circuit board 121, and a recess corresponding to a lower surface of the protection circuit module 120 may be formed in the lower surface 133 of the insulation case 130 such that the protection circuit module 120 fits into the insulation case 130.

In one embodiment, the lower surface 133 of the insulation case 130 may have an area substantially equal to an area of the circuit board 121, and may spatially, as well as electrically, separate (e.g., completely separate) the protection device 122 and the safety device 123 from the bare cell 110. The barrier walls 134 formed in the insulation case 130 may spatially separate the protection device 122 and the safety device 123 from each other.

Referring to FIG. 1, in one embodiment, the upper cover 140 is combined with the upper surface of the bare cell 110 and accommodates the protection circuit module 120. The upper cover 140 may include a cover plate 141 and side walls 142 extending downward from the cover plate 141.

The cover plate 141, in one embodiment, may have a size substantially equal to a size of the upper surface of the bare cell 110, and a through hole 141h may be formed in the cover plate 141 at a position corresponding to the external terminal 125 and may expose the external terminal 125 outside the battery pack 100.

The lower cover 150, in one embodiment, is combined with a lower surface of the bare cell 110, and may include a bottom plate 151 and side walls 152 extending upward from the bottom plate 151. The bottom plate 151, in one embodiment, may have a size substantially equal to a size of the lower surface of the bare cell 110, and may be adhered onto the lower surface of the bare cell 110 by using an adhesive sheet 155.

The label 160, in one embodiment, may be adhered onto and may surround side surfaces of the bare cell 110. Also, the label 160 may cover the side walls 142 of the upper cover 140 and the side walls 152 of the lower cover 150.

In the above-described battery pack 100, since the protection circuit module 120 is disposed at a side of the electrode terminal 113 on the bare cell 110, a space occupied by the protection circuit module 120 in the battery pack 100 may be minimized or reduced. Accordingly, a size of the battery pack 100 may be minimized or reduced, and additional space for mounting other elements may be ensured, thereby greatly increasing the utilization of space.

FIG. 3 is a partial side view of the bare cell 110, an insulation case 130′, and a protection circuit module 120′ of a battery pack 100′ according to another embodiment of the present invention.

Unlike the battery pack 100 illustrated in FIGS. 1 and 2 in which the protection circuit module 120 is disposed at a right side on the bare cell 110, in the battery pack 100′ according to another embodiment of the present invention, the protection circuit module 120′ is disposed at a left side on the bare cell 110.

Referring to FIG. 3, the protection circuit module 120′, in one embodiment, includes a circuit board 121′, and a protection device 122′ and a safety device 123′ mounted on a lower surface of the circuit board 121′, and may be electrically connected to an external electronic device (not shown) via an external terminal (not shown) formed on an upper surface of the protection circuit module 120′.

In one embodiment, a first lead plate 126′ formed at a side of the protection circuit module 120′ contacts the electrode terminal 113, and a second lead plate 127′ formed at another side of the protection circuit module 120′ contacts an upper surface of the bare cell 110 (i.e. a cap plate), and thus the bare cell 110 is electrically connected to the protection circuit module 120′.

In one embodiment, the insulation case 130′ may be formed between the bare cell 110 and the protection circuit module 120′ such that the protection device 122′ and the safety device 123′ mounted on a lower surface of the protection circuit module 120′ are electrically insulated from the bare cell 110.

As described above, the protection circuit module 120 or 120′ may be formed having a slim shape having a small width and length and thus may be selectively disposed on any of symmetrical left and right regions on the bare cell 110. Also, since a space occupied by the protection circuit module 120 or 120′ on the bare cell 110 is reduced or minimized, the utilization of space may be increased in the battery pack 100. Furthermore, an increased amount of space generated due to the protection circuit module 120 or 120′ may be used to increase the capacity of the bare cell 110.

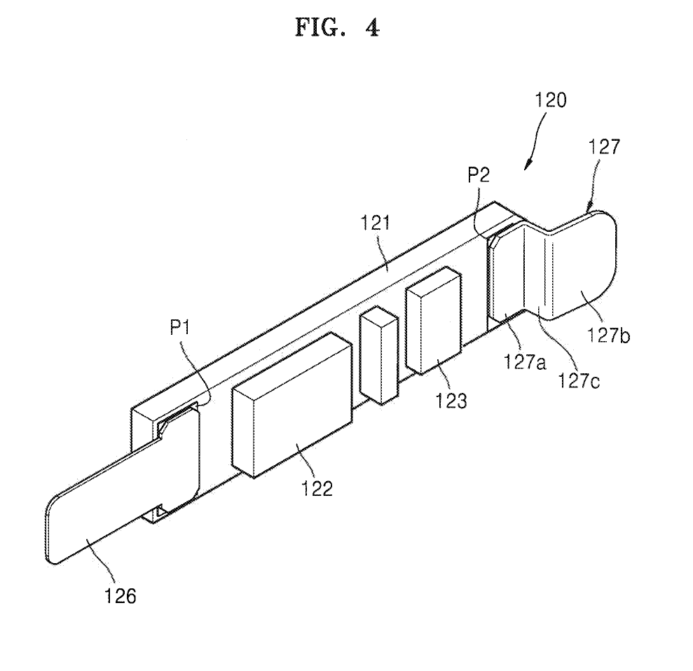

In addition, due to a length-adjustable or length-variable structure, the protection circuit module 120 or 120′ may be generally or universally used regardless of the size or shape of the bare cell 110. The length-adjustable or length-variable structure of the protection circuit module 120 or 120′ and a method of adjusting or varying a length of the protection circuit module 120 or 120′ is described further below with reference to FIGS. 4, and 5A through 5C.

FIG. 4 is a lower perspective view of the protection circuit module 120 of the battery pack 100 illustrated in FIG. 1. FIGS. 5A through 5C are bottom views showing a method of adjusting or varying a length of a lead plate of the protection circuit module 120 illustrated in FIG. 4. In FIGS. 5A through 5C, the protection device 122 and the safety device 123 are not illustrated for reasons of clarity.

Referring to FIG. 4, the protection circuit module 120, in one embodiment, includes the circuit board 121, and the protection device 122 and the safety device 123 mounted on the circuit board 121. An external terminal (not shown) to be electrically connected to an external electronic device (not shown) may be formed on an upper surface of the circuit board 121.

The protection device 122 and the safety device 123 may be mounted on a lower surface of the circuit board 121 such that the space between the bare cell 110 and the circuit board 121 may be efficiently utilized. Descriptions of the protection device 122 and the safety device 123 are set forth above in relation to FIGS. 1 and 2, and thus are not repeated here.

The first lead plate 126 extends from a side of the protection circuit module 120 along a side surface direction by a length (e.g., a predetermined length). One end of the first lead plate 126 is combined with an end of the circuit board 121, and another end (i.e. an opposite end) of the first lead plate 126 is spaced apart from the circuit board 121. The opposite end of the first lead plate 126 is combined with an upper surface of the electrode terminal 113 protruding from the cap plate 112 of the bare cell 110.

The one end of the first lead plate 126 may be bonded onto a first connection pad P1 formed on a rear surface of the circuit board 121 and thus may be combined with the circuit board 121. The first lead plate 126, in one embodiment, may be soldered or welded onto the first connection pad P1. The first connection pad P1 may include a conductive material. For example, in one embodiment, the first connection pad P1 may be formed of a stack of a thin copper (Cu) film and a thin nickel (Ni) film. A coating layer (not shown) for preventing or substantially preventing corrosion may be formed on the first connection pad P1, and, in one embodiment, may include gold (Au).

According to one embodiment of the present invention, the first lead plate 126 may be soldered onto the first connection pad P1 by coating the first connection pad P1 with cream solder, placing the one end of the first lead plate 126 on the first connection pad P1, and passing the circuit board 121 and the first lead plate 126 through a reflow oven. However, the present invention is not limited thereto. For example, in another embodiment, direct soldering may be performed, such as by using a precise soldering device.

According to another embodiment of the present invention, after the one end of the first lead plate 126 is placed on the first connection pad P1, the first lead plate 126 may be welded onto the first connection pad P1 by using a welding rod (not shown).

The second lead plate 127 extends from another side (i.e. a side opposite the first lead plate 126) of the protection circuit module 120 along a side surface direction by a length (e.g., a predetermined length). One end of the second lead plate 127 is combined with the opposite end of the circuit board 121, and another end of the second lead plate 127 is spaced apart from the circuit board 121. The second lead plate, in one embodiment, may be bent.

In one embodiment, the first lead plate 126 is bonded onto the electrode terminal 113 protruding from the upper surface of the bare cell 110, and the first lead plate 126 may have a substantially flat shape. The first lead plate may extend substantially straight from the side of the circuit board 121. The second lead plate 127 is bonded onto the upper surface of the bare cell 110 (i.e. the cap plate 112), and, in one embodiment, the second lead plate 127 is bent to compensate for the height of the electrode terminal 113. For example, the second lead plate 127 may be bent in a generally “Z” shape and, in one embodiment, may include a first lead unit 127a contacting a second connection pad P2, a second lead unit 127b contacting the cap plate 112, and a third lead unit 127c perpendicularly connecting the first and second lead units 127a and 127b.

The one end of the second lead plate 127 may be bonded onto the second connection pad P2 formed on a rear surface of the circuit board 121 and thus may be combined with the circuit board 121. The second lead plate 127, in one embodiment, may be soldered or welded onto the second connection pad P2. The second connection pad P2 may include a conductive material such as Cu foil. The soldering or welding method of the second lead plate 127 may be as described above in relation to the first lead plate 126.

Referring to FIGS. 5A through 5C, the protection circuit module 120 may be generally used regardless of the type of the bare cell 110 by adjusting or varying a bonding position of at least one of the first and second lead plates 126 and 127 on the circuit board 121.

For example, a relative position between the first connection pad P1 of the circuit board 121 and the one end of the first lead plate 126 may be adjustable or variable. For example, if the upper surface of the bare cell 110 has a small length, that is, if the bare cell 110 has a small width, the upper surface of the bare cell 110 may not have a sufficient space for arranging the protection circuit module 120 in a state illustrated in FIG. 5A. Accordingly, as illustrated in FIG. 5B or 5C, the first lead plate 126 may be disposed to increase an overlapping region between the first lead plate 126 and the circuit board 121. In other words, the total length of the protection circuit module 120 may be adjusted or varied by disposing the first lead plate 126 to increase or decrease a contact area between the first lead plate 126 and the first connection pad P1.

Although the total length of the protection circuit module 120 may be adjusted or varied by adjusting or varying a bonding position between the first lead plate 126 and the circuit board 121 as described above, the present invention is not limited thereto. For example, in another embodiment, the total length of the protection circuit module 120 may also be adjusted or varied by adjusting or varying a bonding position between the second lead plate 127 and the circuit board 121.

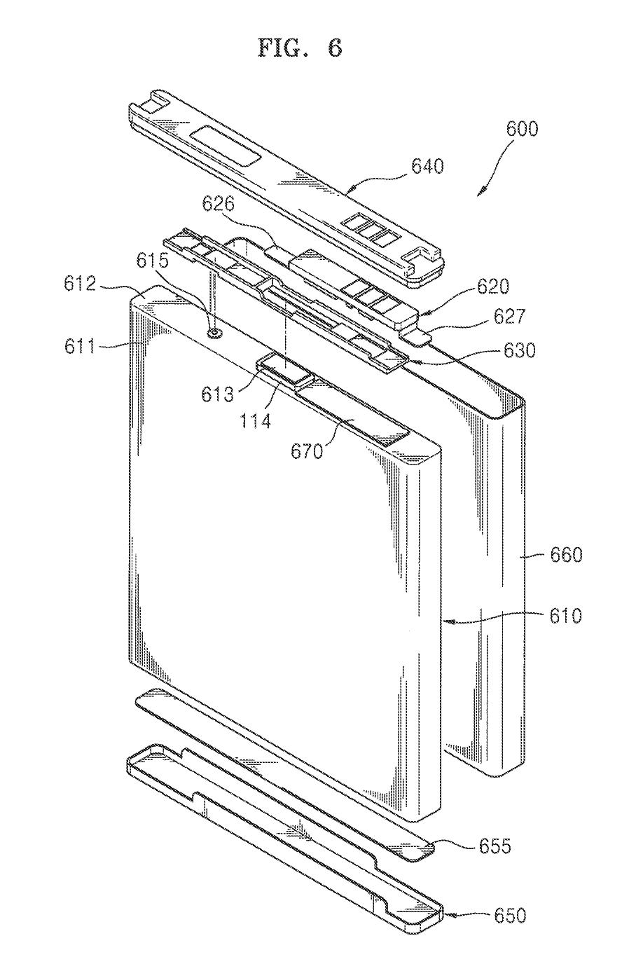

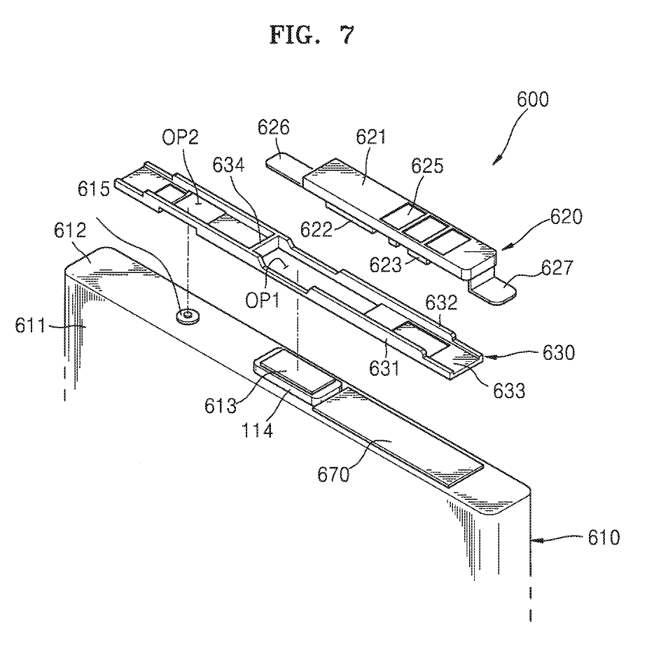

FIG. 6 is an exploded perspective view of a battery pack 600 according to another embodiment of the present invention. FIG. 7 is a partial exploded perspective view of a bare cell 610, an insulation case 630, and a protection circuit module 620 of the battery pack 600 illustrated in FIG. 6.

Referring to FIGS. 6 and 7, the battery pack 600, in one embodiment, may include the bare cell 610, the protection circuit module 620, the insulation case 630, an upper cover 640, a lower cover 650, an adhesive sheet 655, and a label 660. The protection circuit module 620 includes first and second lead plates 626 and 627 at two ends (i.e. opposite ends) to be electrically connected to the bare cell 610. In one embodiment, as described above with respect to FIGS. 5A through 5C, a total length of the protection circuit module 620 may be adjusted or varied. Hereinafter, for convenience of explanation, identical elements between the battery pack 600 and the battery pack 100 or 100′ illustrated in FIGS. 1 through 4, and 5A through 5C will not be repeatedly described, and only those elements and features that are different will be described.

In one embodiment, the insulation case 630 arranged between an upper surface of the bare cell 610 and the protection circuit module 620 has a length greater than a total length of the protection circuit module 620. The insulation case 630, in one embodiment, includes first and second side walls 631 and 632 extending along a lengthwise direction of the insulation case 630, a barrier wall 634 formed substantially perpendicularly to the first and second side walls 631 and 632, and a lower surface 633 facing and corresponding to a protection device 622 or a safety device 623 of the protection circuit module 620.

The first and second side walls 631 and 632, in one embodiment, are spaced apart from each other by a distance substantially equal to a width of a circuit board 621 of the protection circuit module 620, and a recess corresponding to a lower surface of the protection circuit module 620 may be formed in the lower surface 633 of the insulation case 630 such that the protection circuit module 620 fits into the insulation case 630.

The barrier wall 634, in one embodiment, may be formed at a position corresponding to a side of an electrode terminal 613 of the bare cell 600 so as to guide the position of the insulation case 630. For example, the insulation case 630 may be disposed on the upper surface of the bare cell 610 such that the barrier wall 634 contacts a side (e.g., a side opposite the protection circuit module 620) of the electrode terminal 613, thereby guiding the position of the insulation case 630.

The lower surface 633 of the insulation case 630, in one embodiment, prevents or substantially prevents a lower surface of at least one of the protection device 622 and the safety device 623 from directly contacting the upper surface of the bare cell 610. In one embodiment, the lower surface 633 of the insulation case 630 has a first opening OP1 in a region corresponding to the electrode terminal 613 such that the first lead plate 626 of the protection circuit module 620 accommodated in the insulation case 630 may contact the electrode terminal 613.

As described above in relation to FIGS. 1 through 4, and 5A through 5C, the total length of the protection circuit module 620 may be adjusted or varied by adjusting or varying a bonding position between a first connection pad (not shown) formed on a lower surface of the circuit board 621 and the first lead plate 626. A relative bonding position between the first lead plate 626 and the electrode terminal 613 may be changed according to the bonding position between one end of the first lead plate 626 and the first connection pad. Accordingly, the first opening OP1 may be formed with an extra margin such that another end of the first lead plate 626 is bondable onto the electrode terminal 613 even when a bonding position of the first lead plate 626 is changed to adjust or vary the length of the protection circuit module 620. For example, the first opening OP1 may have a size greater than the size of the electrode terminal 613.

Since the first opening OP1, in one embodiment, may be formed with an extra margin, the insulation case 630 does not need to be re-manufactured when the total length of the protection circuit module 620 is adjusted or varied.

In one embodiment, an insulation sheet 670 may be further included to prevent or substantially prevent the protection device 622 or the safety device 623 from contacting the upper surface of the bare cell 610 through the first opening OP1 formed with an extra margin.

In one embodiment, the lower surface 633 of the insulation case 630 may have a second opening OP2 in a region corresponding to an electrolyte inlet (not shown) formed in a cap plate 612 of the bare cell 610 such that an electrolyte may be inserted through the electrolyte inlet after a can 611 of the bare cell 610 and the cap plate 612 are combined. The electrolyte inlet may be sealed with a stopper 615.

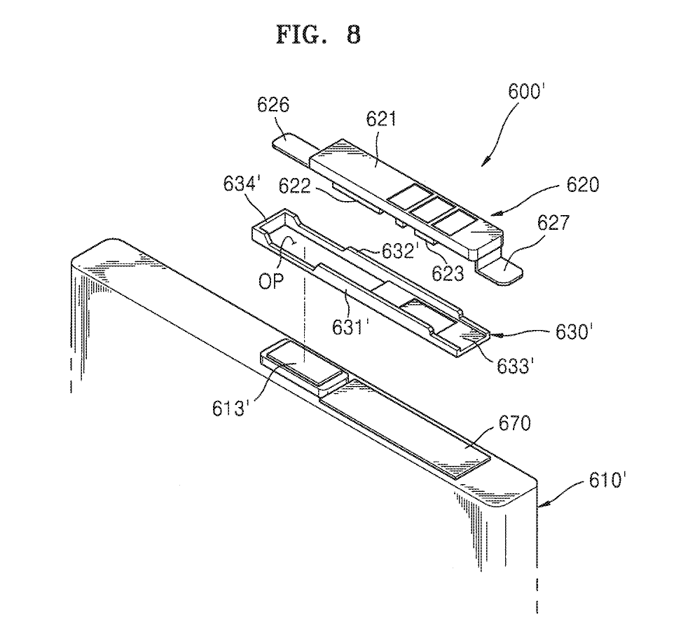

FIG. 8 is a partial exploded perspective view of a bare cell 610′, an insulation case 630′, and the protection circuit module 620 of a battery pack 600′ according to another embodiment of the present invention.

The protection circuit module 620 of the battery pack 600′ includes the first and second lead plates 626 and 627 at two ends (i.e. opposite ends) to be electrically connected to the bare cell 610′. As described above in relation to FIGS. 5A through 5C, a total length of the protection circuit module 620 may be adjusted or varied. Hereinafter, for convenience of explanation, identical elements between the battery pack 600′ and the battery pack 600 illustrated in FIGS. 6 and 7 will not be repeatedly described, and only those elements and features that are different will be described.

The insulation case 630′, in one embodiment, arranged between an upper surface of the bare cell 610′ and the protection circuit module 620 has a length that is substantially equal to a sum of a length of the protection circuit module 620 and a length of an electrode terminal 613′ of the bare cell 610′. The insulation case 630′, in one embodiment, includes first and second side walls 631′ and 632′ extending along a lengthwise direction of the insulation case 630′, a barrier wall 634′ formed substantially perpendicularly to the first and second side walls 631′ and 632′ at ends of the first and second side walls 631′ and 632′, and a lower surface 633′ facing and formed to correspond to the protection device 622 or the safety device 623.

The first and second side walls 631′ and 632′, in one embodiment, are spaced apart from each other by a distance substantially equal to a width of the circuit board 621, and a recess corresponding to a lower surface of the protection circuit module 620 may be formed in the lower surface 633′ of the insulation case 630′ such that the protection circuit module 620 fits into the insulation case 630′.

The barrier wall 634′ may guide the position of the insulation case 630′. For example, the insulation case 630′ may be disposed on the upper surface of the bare cell 610′ such that the barrier wall 634 contacts a side of the electrode terminal 613′ (e.g., a side opposite the protection circuit module 620), thereby guiding the position of the insulation case 630′.

The lower surface 633′ of the insulation case 630′, in one embodiment, prevents or substantially prevents a lower surface of at least one of the protection device 622 and the safety device 623 from directly contacting the upper surface of the bare cell 610′, and may have an opening OP such that the first lead plate 626 of the protection circuit module 620 may directly contact the electrode terminal 613′.

The opening OP, in one embodiment, may be formed with an extra margin such that another end of the first lead plate 626 is bondable onto the electrode terminal 613′ even when a bonding position of the first lead plate 626 is changed to adjust or vary the length of the protection circuit module 620. The opening OP may be formed with an extra margin, and, therefore, the insulation case 630′ does not need to be re-manufactured when the total length of the protection circuit module 620 is adjusted or varied.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. Descriptions of features or aspects within each embodiment should typically be considered as available for other similar features or aspects in other embodiments.

What is claimed is:

1. A battery pack comprising:
a bare cell comprising an electrode assembly, a can accommodating the electrode assembly, and a terminal electrically coupled to the electrode assembly;
a protection circuit module electrically connected to the bare cell; and
a first lead plate connected between the protection circuit module and the terminal,
wherein the protection circuit module is offset from the terminal in a first direction toward a side of the bare cell at a first end of the bare cell.

2. The battery pack of claim 1, wherein the protection circuit module comprises a circuit board and a protection device mounted to a side of the circuit board facing the bare cell.

3. The battery pack of claim 2, further comprising an insulation case comprising a base between and separating the bare cell and the protection device.

4. The battery pack of claim 3, wherein the insulation case further comprises a barrier wall extending from the base, the barrier wall between and separating the protection device and another device mounted to the side of the circuit board.

5. The battery pack of claim 3, wherein the insulation case further comprises first and second side walls extending from the base and defining a recess therebetween receiving the protection device.

6. The battery pack of claim 2, wherein a length of the circuit board along a lengthwise direction of the first end of the bare cell is less than half of a length of the first end of the bare cell along the lengthwise direction.

7. The battery pack of claim 1,
wherein the protection circuit module comprises a circuit board and a first connection pad on the circuit board, and
wherein the first lead plate extends from a side of the protection circuit module toward a second direction opposite the first direction and contacts a portion of the first connection pad.

8. The battery pack of claim 7, wherein the first lead plate partially overlaps the first connection pad.

9. The battery pack of claim 1,
wherein the bare cell further comprises a cap plate closing an opening of the can, the terminal protruding through the cap plate to an outside of the can, and
wherein the battery pack further comprises a second lead plate connecting the protection circuit module to the cap plate.

10. The battery pack of claim 9, wherein the second lead plate is bent toward a bending direction and has a length in the bending direction corresponding to a height of the terminal from the cap plate.

11. The battery pack of claim 1, wherein the first lead plate extends substantially straight from a side of the protection circuit module toward a second direction opposite the first direction.

12. The battery pack of claim 1, further comprising an insulation case between the bare cell and the protection circuit module.

13. The battery pack of claim 12, wherein the insulation case is offset from the terminal in the first direction toward the side of the bare cell.

14. The battery pack of claim 12, wherein the insulation case has a first opening exposing the terminal for connection to the first lead plate.

15. The battery pack of claim 14, wherein the insulation case comprises a barrier wall at a location corresponding to a side of the terminal opposite the protection circuit module.

16. The battery pack of claim 14, wherein the insulation case has a length greater than a total length of the protection circuit module and the first lead plate.

17. The battery pack of claim 16,
wherein the bare cell further comprises an electrolyte inlet at a side of the first end opposite the protection circuit module, and
wherein the insulation case has a second opening at a location corresponding to the electrolyte inlet.

18. The battery pack of claim 14, wherein a length of the first opening along a lengthwise direction of the first end of the bare cell is greater than a length of the terminal along the lengthwise direction.

19. The battery pack of claim 18, wherein the protection circuit module is spaced apart from the bare cell.

20. The battery pack of claim 19, further comprising an insulation sheet between the bare cell and the insulation case at a location corresponding to the protection circuit module.
